(19) United States
(12) Patent Application Publication
(10) Pub. No.: US 2007/0178884 A1
(43) Pub. Date: Aug. 2, 2007

(54) Remote Provisioning of Privacy Settings in a Home Multimedia Network

(75) Inventors: Patrick J. Donovan, Westford, MA (US); Robert C. Booth, Ivyland, PA (US); Colin D. Hayward, Newton, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/566,905

(22) Filed: Dec. 5, 2006

Related U.S. Application Data
(60) Provisional application No. 60/748,060, filed on Dec. 7, 2005.

(51) Int. Cl. H04M 1/66

(52) U.S. Cl. 455/411; 455/432.3

(57) ABSTRACT

An arrangement is provided for remotely provisioning a commonly-utilized PIN from a wide area network (“WAN”) to one or more terminals to thereby enable content to be securely shared over a local area network (“LAN”). The LAN and WAN share portions of a common network infrastructure, but operate at different frequencies. A billing system at the headend of the WAN identifies particular terminals associated with a subscriber who orders a networked DVR service. A PIN server at the headend generates the common PIN that is transmitted to the identified terminals over the WAN. The terminals are able to form a secure LAN through an authentication process utilizing the common PIN. Terminals which are not authenticated are denied access to the LAN thus ensuring that content stored on the DVR is not unintendedly consumed by terminals that are not authorized to receive it.

### STATEMENT OF RELATED APPLICATION

This application claims the benefit of U.S. Provisional Patent Application Ser. No. 60/748,060 filed Dec. 7, 2005, which is incorporated by reference herein.

### FIELD OF THE INVENTION

This invention is related generally to networking, and more particularly to remote provisioning of privacy settings in a home multimedia network.

### BACKGROUND OF THE INVENTION

Digital video recorders (“DVRs”) have become increasingly popular for the flexibility and capabilities offered to users in selecting and then recording video content such as that provided by cable and satellite television service companies. DVRs are consumer electronics devices that record or save television shows, movies, music, and pictures, for example, (collectively “multimedia”) to a hard disk in digital format. Since being introduced in the late 1990s, DVRs have steadily developed additional features and capabilities, such as the ability to record high definition television (“HDTV”) programming. DVRs are sometimes referred to as personal video recorders (“PVRs”).

DVRs allow the “time shifting” feature (traditionally enabled by a video cassette recorder or “VCR” where programming is recorded for later viewing) to be performed more conveniently, and also allow for special recording capabilities such as pausing live TV, fast forward and fast backward, instant replay of interesting scenes, and skipping advertising and commercials.

DVRs were first marketed as standalone consumer electronic devices. Currently, many satellite and cable service providers are incorporating DVR functionality directly into their set-top-boxes (“STBs”). As consumers become more aware of the flexibility and features offered by DVRs, they tend to consume more multimedia content. Thus, service providers often view DVR uptake by their customers as being desirable to support the sale of profitable services such as video on demand (“VOD”) and pay-per-view (“PPV”) programming.

Once consumers begin using a DVR, the features and functionalities it provides are generally desired throughout the home. To meet this desire, networked DVR functionality has been developed which entails enabling a DVR to be accessed from multiple rooms in a home over a network. Such home networks often employ a single, large capacity DVR that is placed near the main television in the home. A series of smaller companion terminals, which are connected to other televisions, access the networked DVR over the typically existing coaxial cable in the home. These companion terminals enable users to see the DVR output, and to use the full range of DVR controls (pause, rewind, and fast-forward among them) on the remotely located televisions. In some instances, it is possible for example, to watch one recorded DVR movie in the office while somebody else is watching a different DVR movie in the family room.

The home network must be secured so that the content stream from the DVR is not unintendedly viewed should it leak back through the commonly shared outside coaxial cable plant to a neighboring home or adjacent subscriber in a multiple dwelling unit (“MDU”) such as an apartment building. In some implementations of home networking, a low pass filter is installed at the entry point of the cable to the home to provide radio frequency (“RF”) isolation. In other implementations, a personal identification number (“PIN”) is installed at each terminal in the home network that enables the media content from the DVR to be securely shared. Terminals that do not have the correct PIN are not able to access the network or share the stored content on the networked DVR.

While networked DVRs meet the needs of the market very well, the installation of the low pass filter or the provisioning of the necessary PIN to each terminal can be a potentially time consuming and expensive process for the service provider. Truck roll costs must be borne if an installer must go to the home to manually set the PIN or install the low pass filter. If self-installation of the PIN by the consumer is more preferable, resources must be expended to develop and then support a PIN installation interface that can be successfully utilized by the consumer. In instances where the terminal is pre-provisioned with the PIN, logistical, inventory and supply issues can add to costs. For example, the service provider must either develop tools to set the PIN when the devices are offline at a warehouse or otherwise have personnel set the PIN manually. In addition, the service provider must develop and maintain facilities to manage and track PINs for additional terminals that are needed to accommodate growth of a consumer's home network.

### BRIEF DESCRIPTION OF THE DRAWING

FIG. 1 is a pictorial representation of an illustrative home network having a plurality of terminal devices that are coupled to several broadband multimedia sources;

FIG. 2 is a block diagram of an illustrative multimedia delivery network having a network headend, hubs coupled to the headend, and nodes coupled to the hubs, where the nodes each provide broadband multimedia services to a plurality of homes;

FIG. 3 is a pictorial representation of an illustrative multiple dwelling unit having a number of apartments, each with a plurality of terminal devices, where the apartments share common infrastructure to receive broadband multimedia services;

FIG. 4 is a block diagram of an illustrative wide area network and a local area network which share a common portion of physical infrastructure;

FIG. 5 is a functional block diagram of an illustrative local area network having a plurality of terminal devices that are also coupled to a wide area network;

FIG. 6 is a pictorial illustration of graphical user interfaces displayed on a home multimedia server and client set-top-box;

FIG. 7 is functional block diagram showing an illustrative network headend coupled over a wide area network to the premises of a subscriber;

FIG. 8 is a flowchart of an illustrative method for installing a common personal identification number on a plurality of terminals so that the terminals may securely share content over a local area network;

FIG. 9 is a functional block diagram of an illustrative media server that is coupled to a wide area network and a local area network;

FIG. 10 is a diagram showing an illustrative shared-key authentication message flow between terminals over a local area network;

FIG. 11 is a flowchart of an illustrative method for authenticating terminals that are seeking to access a local area network to thereby securely share content with the terminal once authenticated; and

FIG. 12 is a flowchart of an illustrative method used by a terminal to request access to a local area network to thereby securely share content with other terminals on the network.

### DETAILED DESCRIPTION

An arrangement is provided for remotely provisioning a commonly-utilized PIN over a wide area network (“WAN”) to one or more terminals to thereby enable content to be securely accessed and shared over a local area network (“LAN”). In illustrative examples, the WAN is a broadband multimedia content delivery service network which is selected from a cable network, telecommunications network, or direct satellite broadcast (“DBS”) network. The LAN in one illustrative example is a network that operates over coaxial cable in a home that enables discrete pieces of multimedia content stored (i.e., an individually titled work such as a television program, movie or event) on a networked DVR disposed in one terminal (such as a STB) to be accessed and shared with terminals located throughout the home. The LAN and WAN share portions of a common network infrastructure, but operate at different frequencies.

A billing system at the headend of the WAN provides data to identify the particular terminals associated with a subscriber who orders a networked DVR service. A PIN server at the headend receives the billing system data, responsively generates the common PIN, and transmits the common PIN to the identified terminals over the WAN.

The terminals use the common PIN to form a secure home LAN, which in one illustrative example, is implemented using shared-key authentication. Terminals seeking to access the home LAN are authenticated with the common PIN. Terminals which are not authenticated are denied access to the home LAN thus ensuring that content stored on the DVR is not unintendedly consumed by terminals that are not authorized to receive it.

Such arrangement provides a number of advantages. The common PIN provisioning using a broadband multimedia service operating through a WAN may typically be highly automated. Thus costs associated with a truck roll service call and the support and maintenance costs attendant to self-installation by the subscriber or warehouse PIN provisioning are reduced or eliminated.

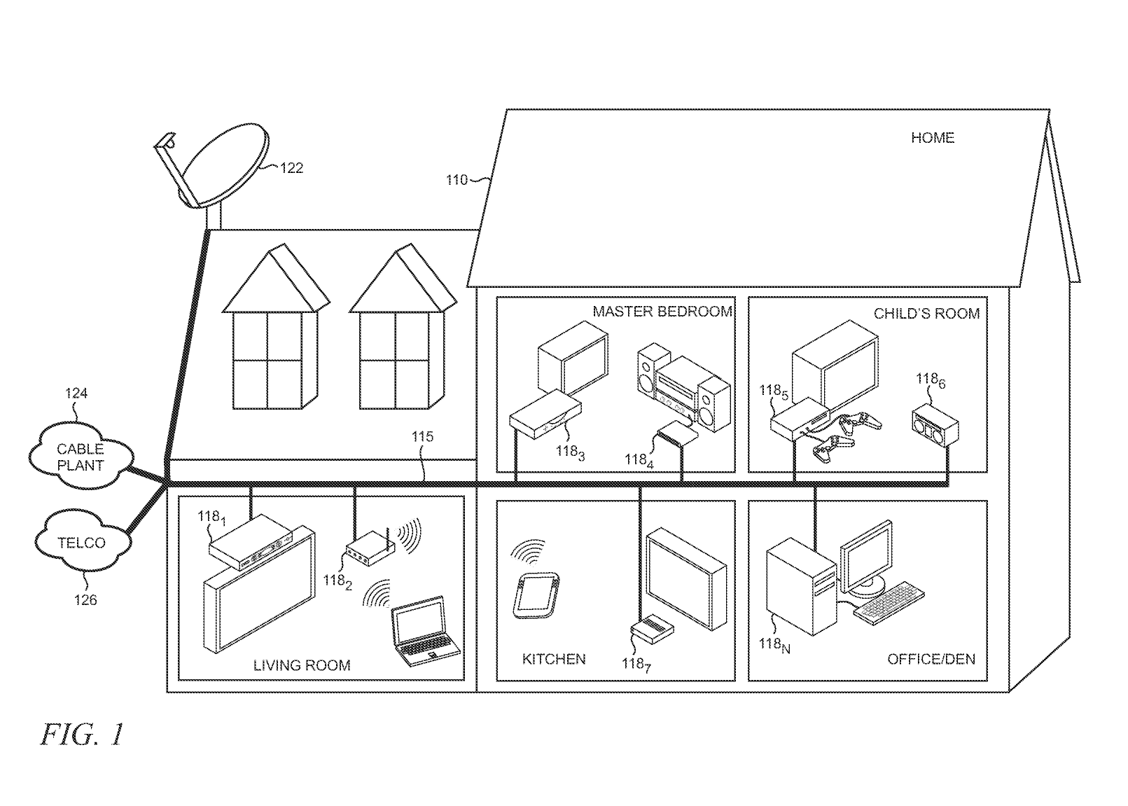

Turning now to FIG. 1, a pictorial representation of an illustrative arrangement is provided which shows a home 110 with infrastructure 115 to which a plurality of illustrative terminal devices 118₁ to 118_{N} are coupled. Connected to the terminal devices 118 are a variety of consumer electronic devices that are arranged to consume multimedia content. For example, terminal device 118₁ is an STB with an integrated networkable DVR which functions as a home network multimedia server, as described in detail below.

Several network sources are coupled to deliver broadband multimedia content to home 110 and are typically configured as WANs. A satellite network source, such as one used in conjunction with a DBS service is indicated by reference numeral 122. A cable plant 124 and a telecommunications network 126, for example for implementing a digital subscriber line (“DSL”) service, are also coupled to home 110.

In the illustrative arrangement of FIG. 1, infrastructure 115 is implemented using coaxial cable that is run to the various rooms in the house, as shown. Such coaxial cable is commonly used as a distribution medium for the multimedia content provided by network sources 122, 124 and 126. In alternative examples, infrastructure 115 is implemented using telephone or power wiring in the home 110. In accordance with the present arrangement for remotely provisioning a common PIN, infrastructure 115 also supports a home LAN, and more particularly, a home multimedia network.

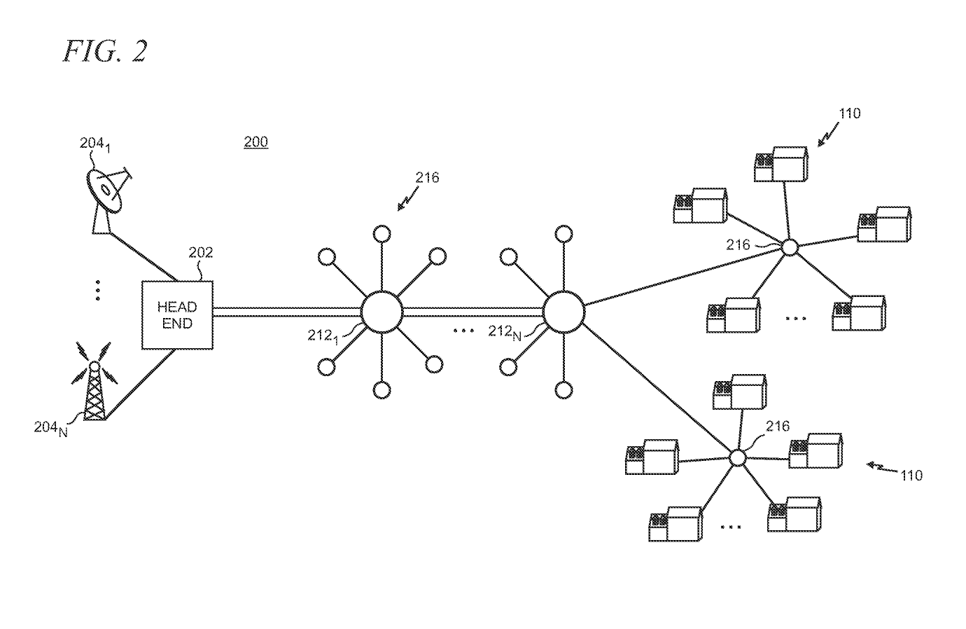

FIG. 2 is a block diagram of an illustrative multimedia delivery network 200 having a network headend 202, hubs 212₁ to 212_{N} coupled to the headend 202, and nodes (collectively indicated by reference numeral 216) coupled to the hubs 212. Nodes 216 each provide broadband multimedia services to a plurality of homes 110, as shown. Multimedia delivery network 200 is, in this example, a cable television network. However, DBS and telecommunication networks are operated with substantially similar functionality.

Headend 202 is coupled to receive programming content from sources 204, typically a plurality of sources, including an antenna tower and satellite dish as in this example. In various alternative applications, programming content is also received using microwave or other feeds including direct fiber links to programming content sources.

Network 200 uses a hybrid fiber/coaxial (“HFC”) cable plant that comprises fiber running among the headend 202 and hubs 212 and coaxial cable arranged as feeders and drops from the nodes 216 to homes 110. Each node 216 typically supports several hundred homes 110 using common coaxial cable infrastructure in a tree and branch configuration. As a result, as noted above, the potential exists for content stored on a networked DVR in one home on a node to be unintendedly viewed by another home on the node unless steps are taken to isolate the portions of the cable plant in each home that are utilized to implement the home multimedia network.

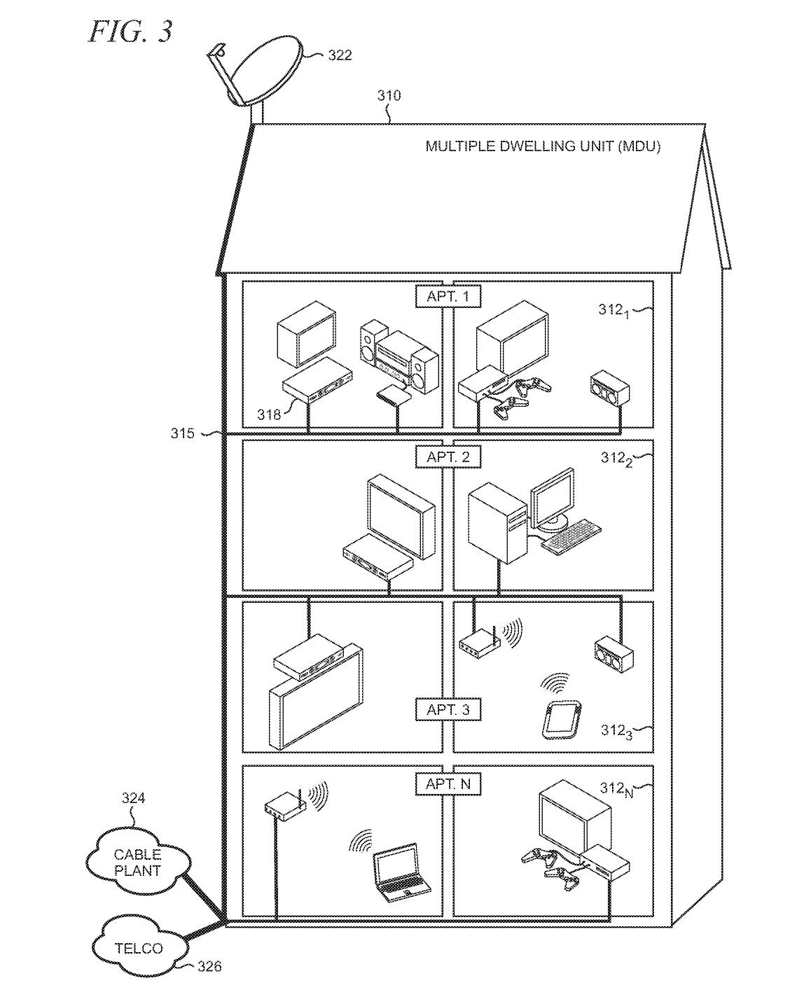

FIG. 3 is a pictorial representation of an illustrative multiple dwelling unit 310 having a number of apartments 312₁ to 312_{N}, each with a plurality of terminal devices coupled to a common coaxial cable infrastructure 315. In a similar manner to that shown in FIG. 1 and described in the accompanying text, MDU 310 receives broadband multimedia services from WANs including a satellite network source 322, cable plant 324 and telecommunications network 326.

Apartments 312 each use respective portions of infrastructure 315 to implement a LAN comprising a home multimedia network. Since apartments 312 share common infrastructure 315, measures must be taken to isolate each home multimedia network in the MDU so that content stored on a networkable DVR in STB 318, for example in apartment 1, is not unintendedly viewed in apartment 2 in MDU 310.

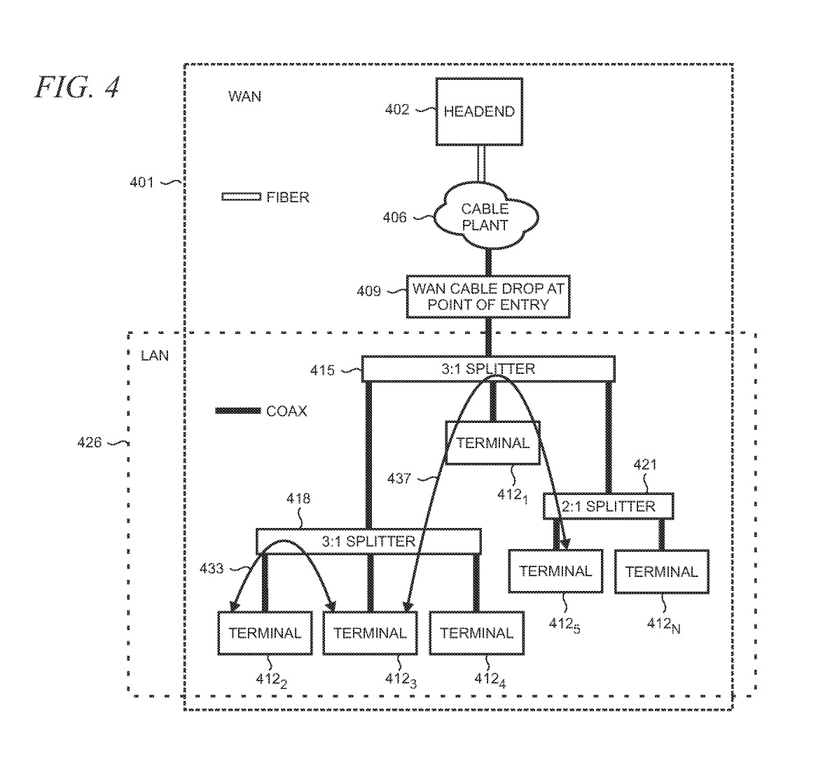

FIG. 4 shows an example of how the wide area and local area networks described above share a common portion of physical infrastructure. A WAN 401, for example a cable television network, includes a headend 402 and cable plant 406. Cable plant 406 is typically arranged as a HFC network having coaxial cable drops at a plurality of terminations at broadband multimedia service subscribers' buildings such as homes, offices, and MDUs. One such cable drop is indicated by reference number 409 in FIG. 4.

From the cable drop 409, WAN 401 is coupled to individual terminals 412, to 412_{N} using a plurality of splitters, including 3:1 splitters 415 and 418 and a 2:1 splitter 421 and coaxial cable (indicated by the heavy lines in FIG. 4). It is noted that the number and configuration of splitters shown in FIG. 4 is illustrative and other types and quantities of splitters will vary depending on the number of terminals deployed in a particular application. Headend 402 is thus coupled directly to each of the terminals 412 in the premises to enable multimedia content to be streamed to the terminals over the WAN 401. In most applications, terminals 412 and cable plant 406 are arranged with two-way communication capability so that signals which originate at a subscriber's premises can be delivered back upstream to the headend. Such capability enables the implementation of a variety of interactive services. It further provides a subscriber with a convenient way to order services from the headend, make queries as to account status, and browse available multimedia choices using an electronic programming guide (“EPG”), for example.

In typical applications WAN 401 operates with multiple channels using RF (radio frequency) signals in the range of 50 to as high as 860 Mhz for downstream communications (i.e., from headend to terminal). Upstream communications (i.e., from terminal to headend) have a typical frequency range from 5 to 42 MHz.

LAN 426 commonly shares the portion of networking infrastructure installed at the building with WAN 401. More specifically, as shown in FIG. 4, the coaxial cable and splitters in the building are used to enable inter-terminal communication. This is accomplished using a network or communications interface in each terminal, such as a network interface module (“NIM”), chipset or other circuits, that provides an ability for an RF signal to jump backwards through one or more splitters. Such splitter jumping is illustratively indicated by arrows 433 and 437 in FIG. 4.

In many applications, LAN 426 is arranged with the capability for operating multiple RF channels in the range of 800-1550 MHz, with a typical operating range of 1 to 1.5 GHz. LAN 426 is generally arranged as an IP (Internet protocol) network. Other networks operating at other RF frequencies may optionally use portions of the LAN 426 and WAN 401 infrastructure. For example, a broadband internet access network using a cable modem (not shown), voice over internet protocol (“VOIP”) network, and/or out of band (“OOB”) control signaling and messaging network functionalities are commonly operated on LAN 426 in many applications.

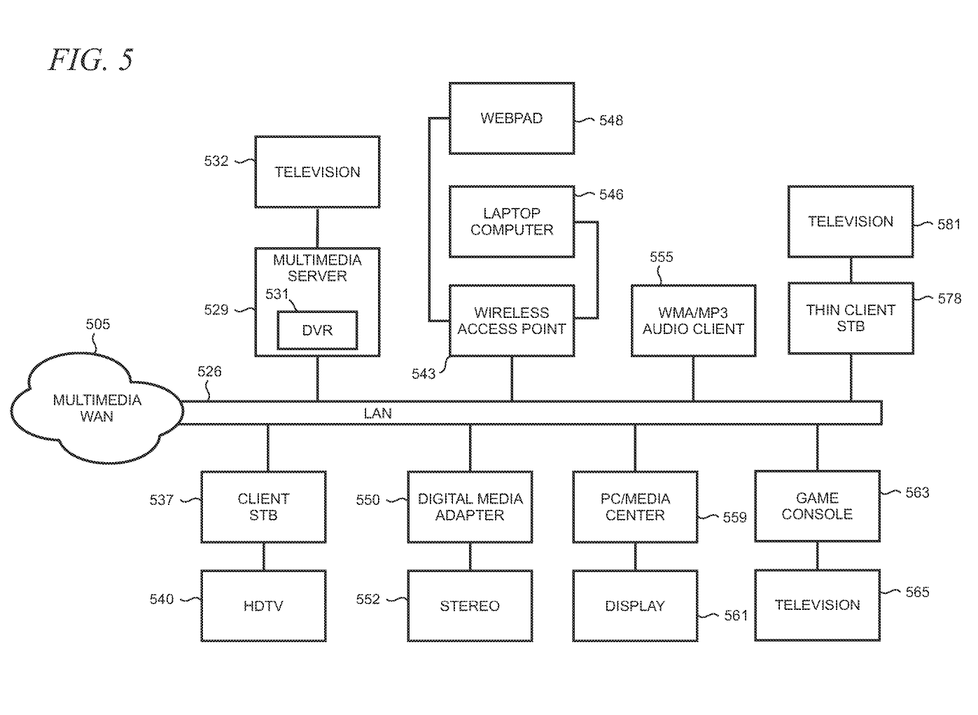

FIG. 5 is a functional block diagram of an illustrative LAN 526 having a plurality of coupled terminal devices that is operated in a multimedia service subscriber's home. As with the arrangement shown in FIG. 4 and described in the accompanying text, the terminal devices coupled to LAN 526 are also coupled to a WAN 505 to receive multimedia content services such as television programming, movies, and music from a service provider. Thus, WAN 505 and LAN 526 share a portion of common networking infrastructure, which in this example is coaxial cable, but operate at different frequencies.

A variety of terminal devices are coupled to LAN 526 in this illustrative example. A multimedia server 529 is coupled to LAN 526. Multimedia server 529 is arranged using an STB with integrated networkable DVR 531. Alternatively, multimedia server is arranged from devices such as personal computers, media jukeboxes, audio/visual file servers, and other devices that can store and serve multimedia content over LAN 526. Multimedia server 529 is further coupled to a television 532.

Client STB 537 is another example of a terminal that is coupled to LAN 526 and WAN 505. Client STB 537 is arranged to receive multimedia content over WAN 505 which is played on the coupled HDTV (high definition television) 540. Client STB 537 is also arranged to communicate with other terminals on LAN 526, including for example multimedia server 529, in order to access content stored on the DVR 531. Thus, for example, a high definition PPV movie that is recorded on DVR 531 in multimedia server 529 located in the living room of the home can be watched on the HDTV 540 in the home's family room.

Wireless access point 543 allows network services and content from WAN 505 and LAN 526 to be accessed and shared with wireless devices such as laptop computer 546 and webpad 548. Such devices with wireless communications capabilities (implemented, for example, using the Institute of Electrical and Electronics Engineers IEEE 802.11 wireless communications protocols) are commonly used in many home networking applications. Thus, for example, photographs stored on DVR 531 can be accessed on webpad 548 that is located in the kitchen of the home over LAN 526.

Digital media adapter 550 allows network services and content from WAN 505 and LAN 526 to be accessed and shared with media players such as home entertainment centers or stereo 552. Digital media adapter 550 is typically configured to take content stored and transmitted in a digital format and convert into an analog signal. For example, a streaming internet radio broadcast received from WAN 505 and recorded on DVR 531 is accessible for playing on stereo 552 in the home's master bedroom.

WMA/MP3 audio client 555 is an example of a class of devices that can access digital data directly without the use of external digital to analog conversion. WMA/MP3 client 555 is a music player that supports the common Windows Media Audio (“WMA”) digital file format and/or the Moving Picture Expert Group (“MPEG”) Audio Layer 3 digital file format (“MP3”), for example. WMA/MP3 audio client 555 might be located in a child's room in the home to listen to a music channel supplied over WAN 505 or access an MP3 music library that is stored on DVR 531 using LAN 526.

A personal computer, PC 559 (which is optionally arranged as a media center-type PC typically having one or more DVD drives, a large capacity hard disk drive, and high resolution graphics adapter) is coupled to WAN 505 and LAN 526 to access and play streamed or stored media content on coupled display device 561 such as a flat panel monitor. PC 559, which for example is located in an office/den in the home, may thus access recorded content on DVR 531, such as a television show, and watch it on the display device 561. In alternative arrangements, PC 559 is used as multimedia server having similar content sharing functionalities and features as multimedia server 529 that is described above.

A game console 563 and coupled television 565, as might be found in a child's room, is also coupled to WAN 505 and LAN 526 to receive streaming and stored media content, respectively. Many current game consoles play game content as well as media content such as video and music. Online internet access is also used in many settings to enable multi-player network game sessions.

Thin client STB 578 couples a television 581 to WAN 505 and LAN 526. Thin client STB is an example of a class of STBs that feature basic functionality, usually enough to handle common EPG and VOD/PPV functions. Such devices tend to have lower powered central processing units and less random access memory than thick client STBs such as multimedia server 529 above. Thin client STB 578 is, however, configured with sufficient resources to host a user interface that enables a user to browse, select, and play content stored on DVR 531 in multimedia server 529. Such user interface is configured, in this illustrative example, using an EPG-like interface that allows remotely stored content to be accessed and controlled just as if the content was originally received by thin client STB 578 and recorded on its own integrated DVR. That is, the common DVR programming controls including picking a program from the recorded library, playing it, using fast forward or fast back, and pause are supported by the user interface hosted on thin client STB 578 in a transparent manner for the user.

It is emphasized that the mix of thick and thin client STBs and other terminal devices utilized in a particular application of remote provisioning of privacy settings in a home multimedia network may vary from that shown in FIG. 5. In addition, the distribution of functionalities across the various elements and terminal devices in a given home network may also vary. For example, the DVR 531 may be alternatively located in other network elements beyond the multimedia server 529. In addition, some functions such as EPG support and content selection (i.e., tuner) capabilities may not necessarily be included in every terminal device coupled to LAN 526 in FIG. 5.

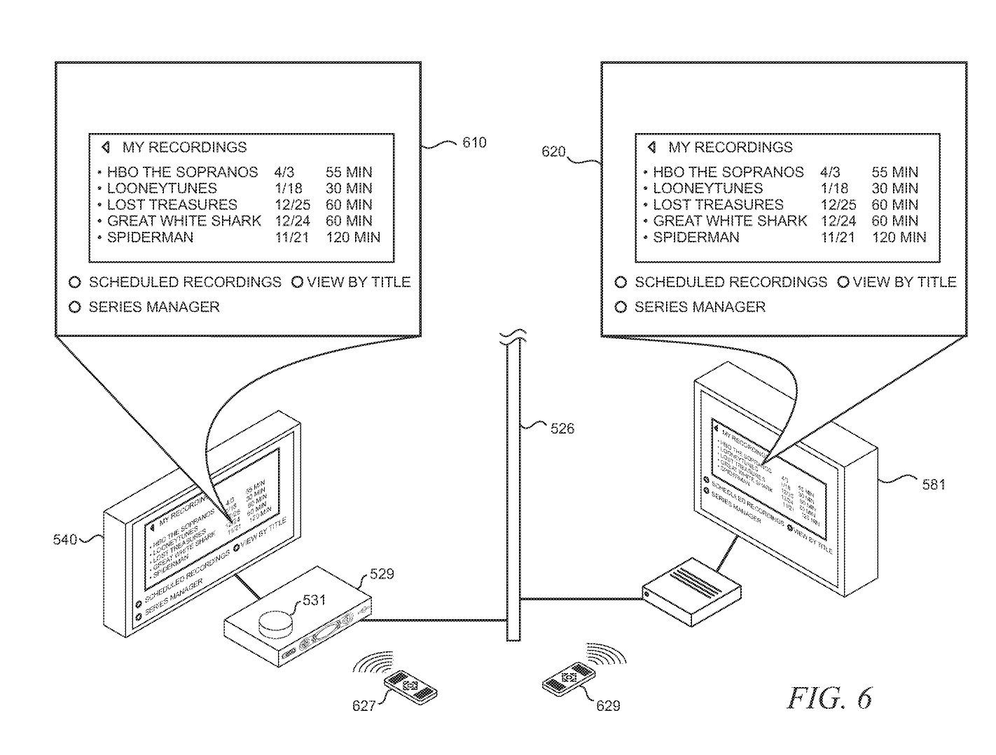

FIG. 6 is a pictorial illustration of the graphical user interfaces displayed on televisions 540 and 581 that are hosted by home multimedia server 529 and thin client STB 578, respectively, which are coupled to LAN 526 as shown. Graphical user interface (“GUI”) 610 shows the content recorded on DVR 531 including a title, date recorded and program length. A user typically interacts with GUI 610 using a remote control 627 to make recordings, set preferences, browse and select the content to be consumed.

Thin client STB 578 hosts GUI 620 with which the user interacts using remote control 629. As shown, GUI 620 displays the same content and controls as GUI 610. Content selected by the user for consumption on television 581 is shared over LAN 526.

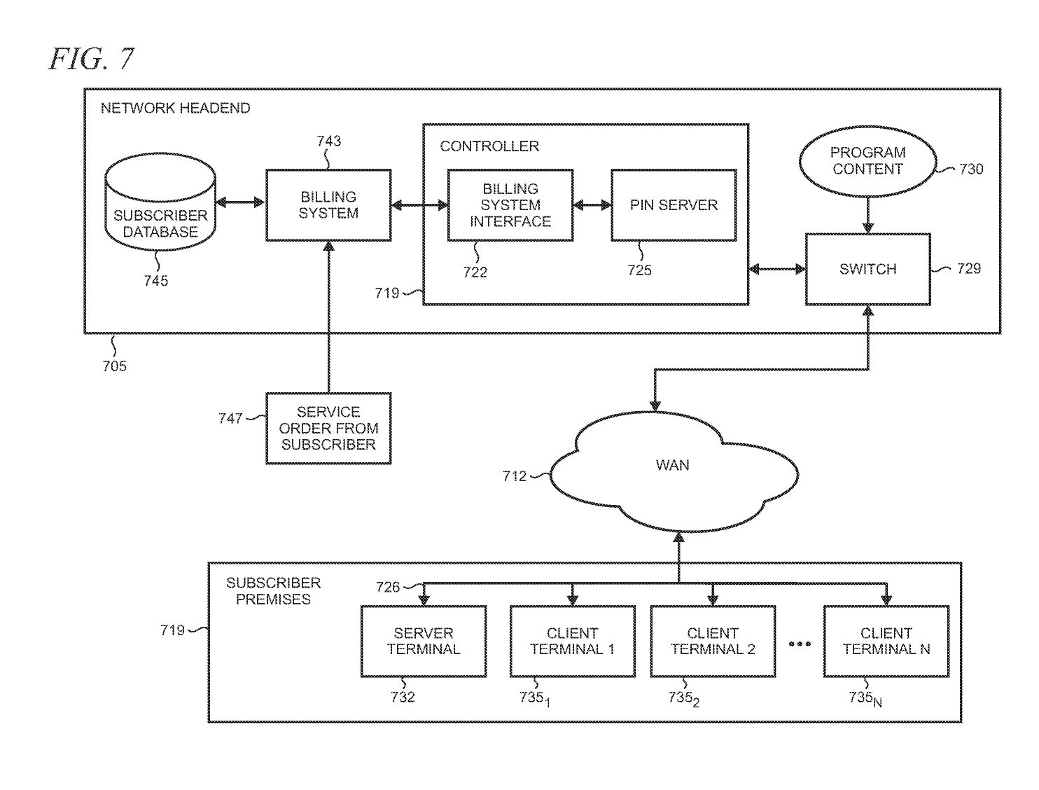

FIG. 7 is functional block diagram showing an illustrative network headend 705 that is coupled over a WAN 712 to subscriber premises 719. WAN 712 is arranged in a similar manner to WAN 401 shown in FIG. 4 and described in the accompanying text. Network headend 705 includes a controller 727 having a billing system interface 722. A PIN server 725 is operatively coupled to the billing system interface 722. Controller 727 is also operatively coupled to a switch 729 (that typically includes multiplexer and/or modulator functionality) that modulates programming content 730 from sources 204 (FIG. 2) on to the WAN 712 along with control information, messages, and other data, using the OOB network.

A plurality of terminals including a server terminal 732 and client terminals 735₁ to 735_{N} are disposed in subscriber premises 719. Server terminal 732 is alternatively arranged with similar features and functions as multimedia server 529 (FIG. 5) or PC/Media Center 559 (FIG. 5). Client terminals 735 are arranged with similar features and functions as client STB 537 or thin client STB 578 (FIG. 5). Server terminal 732 and client terminals 735 are coupled to LAN 726 which is, in this illustrative example, arranged using coaxial cable infrastructure in a similar arrangement as LAN 526 (FIG. 5).

Billing system interface 722 is arranged to receive data from a billing system 743 that is disposed in the network headend 705. Billing system 743 is generally implemented as a computerized, automated billing system that is connected to the outgoing PIN server, among other elements, at the network headend 705. Billing system 743 readily facilitates the various programming and service options and configurations available to subscribers which typically results, for example, in the generation of different monthly billing for each subscriber. Data describing each subscriber, and the programming and service options associated therewith, are stored in a subscriber database 745 that is operatively coupled to the billing system 743.

Service orders from the subscribers are indicated by block 747 in FIG. 7 which are input to the billing system 743. Such orders are generated using a variety of input methods including telephone, internet or website portals operated by the service provider, or via input that comes from a terminal in subscriber premises 719. In this latter case, a user typically interacts with a GUI or EPG that is hosted on one of the terminals 732 and 735.

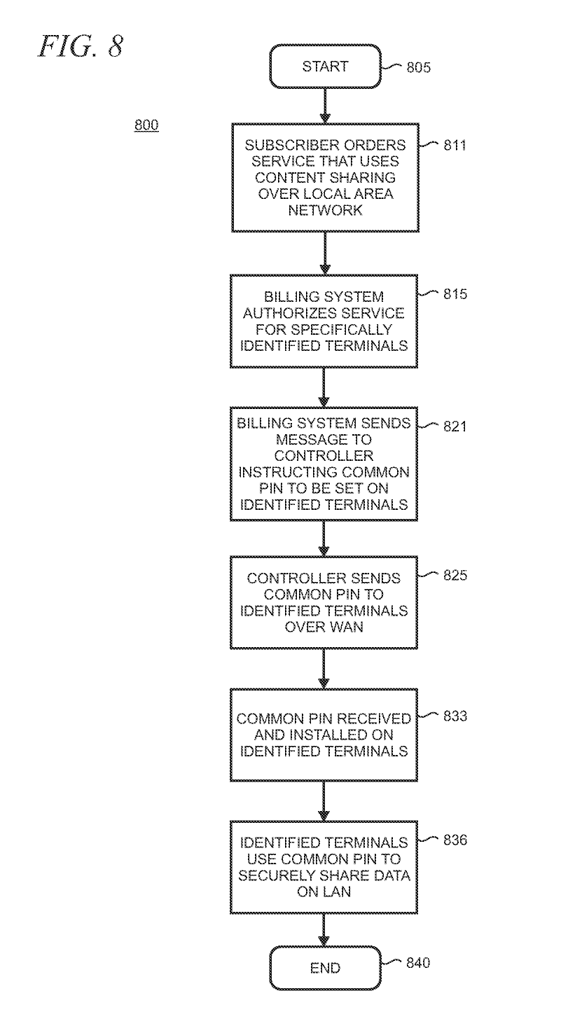

FIG. 8 is a flowchart of an illustrative method 800 for installing a common PIN on a plurality of terminals so that the terminals are able to securely share content over a LAN. Method 800 is performed in part, in one example of remote provisioning of privacy settings, using headend 705 and the network arrangement shown in FIG. 7 and described in the accompanying text. The method starts at block 805.

At block 811, a subscriber orders a service that requires use of a content sharing network that is implemented with a LAN such as LAN 726. Referring again to FIG. 7, such order for service is indicated by block 747 which represents an input to billing system 743. One example of a service that the subscriber might order is for feature-based service like a home multimedia network sharing service such as a whole home or multi-room DVR service. As described above, such service enables a subscriber to conveniently share multimedia (e.g., including video, music and photographs that are recorded or stored on a networked DVR) with terminals that are located throughout the home. Whole home/multi-room DVR services are implemented, in one illustrative example, using the MoCA (Multimedia over Coax Alliance) architecture and associated networking methodology. Here, a MoCA chipset or NIM is utilized to enable terminal-to-terminal communications that are secured using the present remote provisioning of a commonly-utilized PIN. Accordingly, a service enabled by such inter-terminal communications capabilities can be referred to as a “MoCA service” although a particular service provider might call it something else from a service branding point of view.

Other types of services that can be ordered by the subscriber as shown in block 811 are content-based services including recurring services (e.g., a subscription to cable television services that is billed on a monthly basis) or single-event services such as a VOD or PPV event.

At block 815 in FIG. 8, a billing system (e.g., billing system 743) authorizes the ordered service for terminals that it identifies as being associated with the subscriber ordering the service. In most applications, each terminal deployed in a service provider's network has a unique identification that is tracked by the billing system and stored in a subscriber database (e.g., subscriber database 745). Thus, the billing system determines the identity, for example, of each STB in the subscriber's home. The billing system sends a message to the controller with the identification information at block 821.

In response to the message from the billing system, at block 825, the PIN server (e.g., PIN server 725 in controller 727) generates a PIN that is common for all of the identified subscriber STBs. The common PIN is transported over a WAN (e.g., WAN 712), typically in an OOB channel to the identified terminals. The common PIN is received and installed in the identified subscriber terminals at block 833 of the illustrative method.

At block 836, the terminals use the commonly installed PIN to securely share multimedia content and communicate over a LAN (e.g., LAN 726). An example of such secure sharing and communication is provided in the description that follows. The illustrative method ends at block 840.

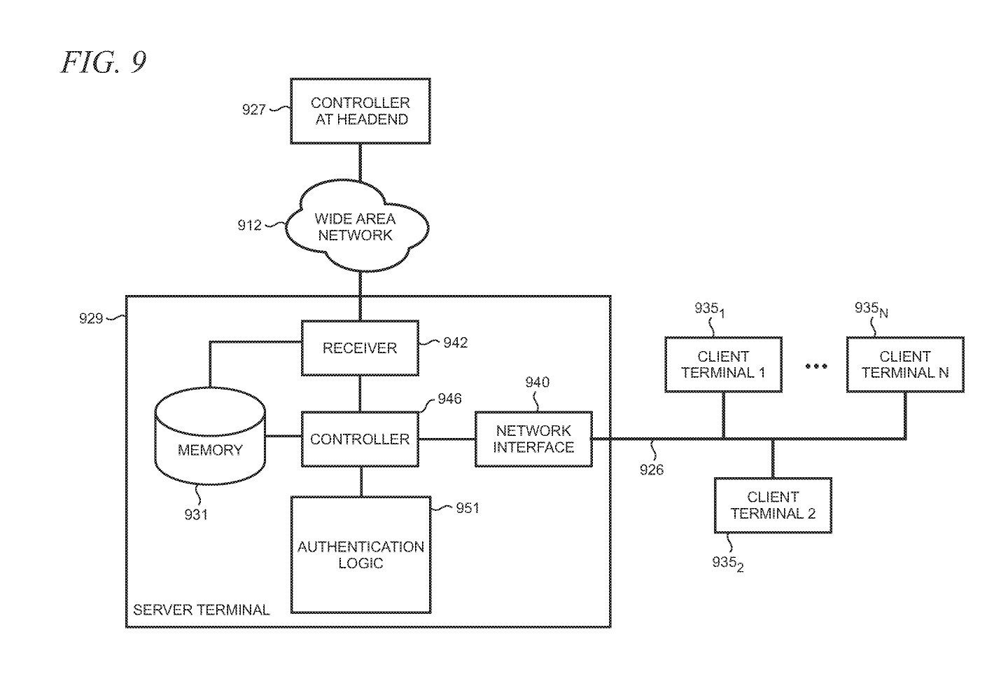

FIG. 9 is a functional block diagram of an illustrative server terminal 929 that is coupled to a WAN 912 and a LAN 926. A controller 927 at a headend provides programming content and a common PIN over WAN 912. WAN 912, LAN 926 and controller 927 are arrangeable in a similar manner as their counterparts shown in FIG. 7 and described in the accompanying text.

Server terminal 929, in this illustrative example, is arranged as a multimedia server in a similar fashion as multimedia server 529 in FIG. 5, and thus includes a memory 931. Memory 931 is alternatively arranged as a hard disk drive or RAM (random access memory). Memory 931 is sharable with the networkable DVR function that is typically included within server terminal 929 in most applications.

It is noted that the architecture for client terminal 935 is similar to that shown in FIG. 9, in most typical applications. However, client terminals generally do not have an integrated DVR functionality. Thus, the memory in a client terminal is configured to be smaller than that in the server terminal and is not normally shared with any DVR functionality.

A number of client terminals 935₁ to 935_{N}, are coupled to server terminal 929 on LAN 926. Server terminal 929 employs a network interface 940 to enable communications using LAN 926 as an IP network.

Server terminal 929 includes a receiver 942 arranged to receive data, including a PIN, from a PIN server (not shown) disposed in the controller 927 at the headend. Receiver 942 is coupled to a controller 946 in server terminal 929 which stores the received PIN in memory 931. Authentication logic 951 is coupled to the controller 946, as shown, that is utilized to perform authentication attendant to the formation of a secure content sharing network as described below.

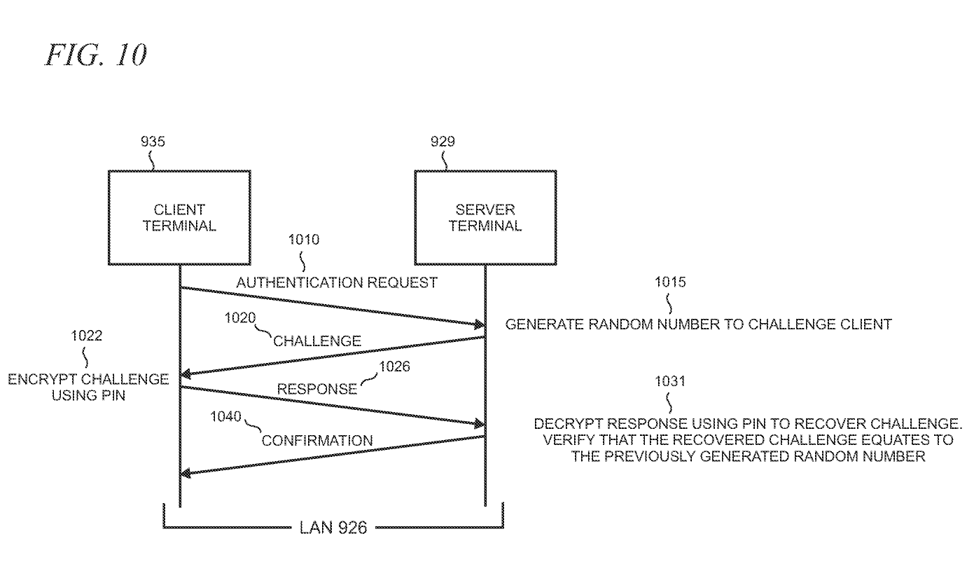

FIG. 10 is a diagram showing an illustrative shared-key authentication message flow between the server terminal 929 and one of the client terminals 935 over LAN 926 that are shown in FIG. 9. In this illustrative example, the messages are conveyed as MAC (media access control) sublayer messages which are transported in the data link layer of the OSI (Open Systems Interconnection) model on the IP network which operates on LAN 926.

Client terminal 935 sends an authentication request message 1010 to server terminal 929. Client terminal 935 sends the authentication request when looking to join (i.e., gain access to) LAN 926 to thereby consume stored content (such as programming recorded on the DVR disposed in the server terminal). In response to the authentication request, server terminal 929 generates a random number as indicated by reference numeral 1015. The random number is used to create a challenge message 1020 which is sent back to client terminal 935.

As indicated by reference numeral 1022 in FIG. 10, client terminal 935 encrypts the challenge using the common PIN (that is received as shown in the illustrative flowchart of FIG. 8 and described in the accompanying text). Client terminal 935 uses any of a variety of known encryption techniques, such as the RC4 stream cipher, to encrypt the challenge (as indicated by reference numeral 1022) using the PIN to initialize a pseudorandom keystream. Client terminal 935 sends the encrypted challenge as a response message 1026 to the server terminal 929.

As indicated by reference numeral 1031 in FIG. 10, the server terminal 929 decrypts the response message 1026 using the common PIN to recover the challenge (i.e., the PIN acts as an encryption and decryption “key”). The recovered challenge from the client terminal 935 is compared against the original random number. If a successful match is identified, a confirmation message 1040 is sent from the server terminal 929 to the client terminal 935.

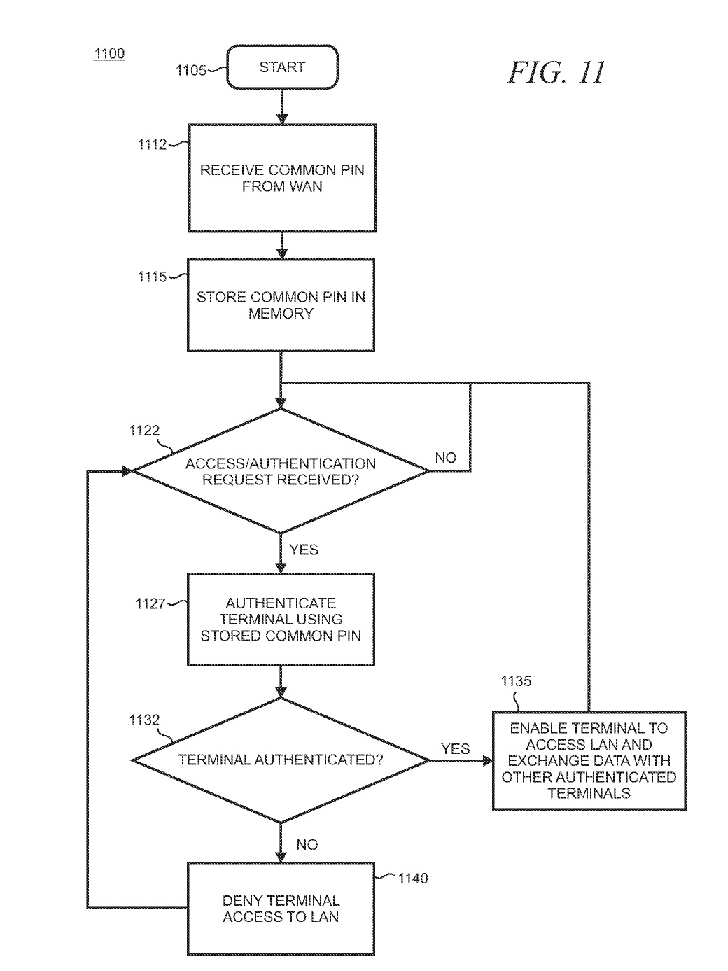

FIG. 11 is a flowchart of an illustrative method 1100 for authenticating terminals as performed, for example, by the terminal server 929 in the arrangement shown in FIG. 9. The method starts at block 11105.

At block 1112, terminal server 929 receives a common PIN from controller 927 at the headend over WAN 912. The common PIN is stored in memory 931 of the terminal server 929 at block 1115.

At decision block 1122, server terminal 929 determines whether an authentication request to join the LAN 926 is received. For example, when a client terminal 935 located in a room in a home is powered on by a user, it recognizes the presence of LAN 926 and sends an authentication request to the server terminal 929.

In response, at block 1127 the client terminal 935 is authenticated using the common PIN and message flow described in the text accompanying FIG. 10. At decision block 1132, the server terminal 929 determines whether the client terminal 935 is authenticated. If the client terminal 935 is successfully authenticated, then it is provided with access to LAN 926 so that it may access and share content with the terminal server 929, as shown at block 1135. In addition, client terminal 935 may access and share content with any other terminal that is already authenticated and thus available for communication over the network on LAN 926. Flow control is then returned back to decision block 1122.

If the client terminal 935 is not successfully authenticated, then it is denied access to LAN 926, as shown at block 1140 in FIG. 11. The authentication would fail when a client terminal does not have a correct PIN as would be the case if the client terminal belongs to another subscriber in a neighboring house or apartment. Alternatively, a client terminal might not have a correct PIN in cases where the subscriber has not authorized shared content for all STBs in the home. For example, a subscriber might wish to restrict access to the networked DVR for an STB in a guest room or a child's room. Flow control is then returned back to decision block 1122.

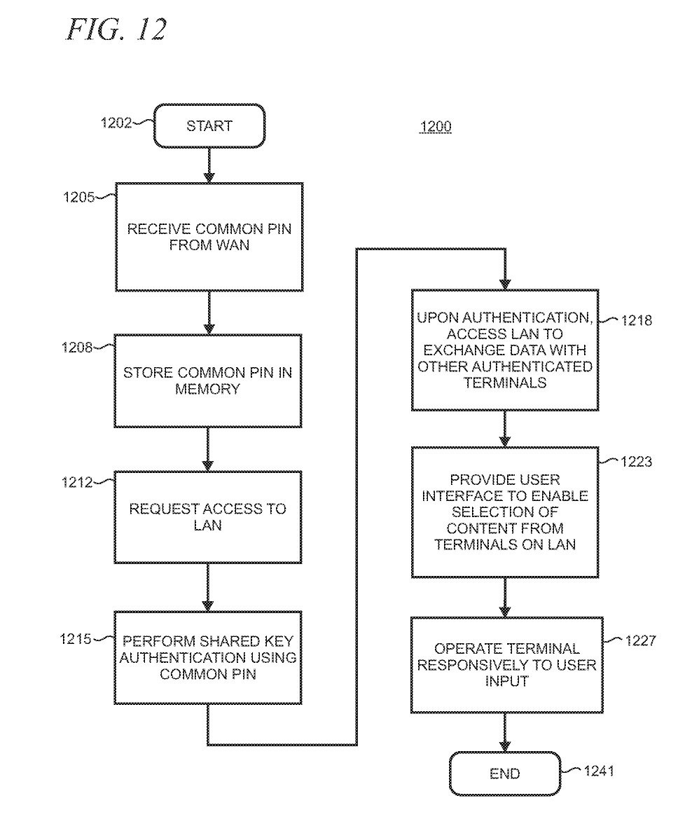

FIG. 12 is a flowchart of an illustrative method 1200 used by a terminal to request access to a local area network to thereby securely share content with other terminals on the network. Such illustrative method is performed, for example, by the client terminal 935 in the arrangement shown in FIG. 9. The method starts at block 1202.

At block 1205, client server 935 receives a common PIN from controller 927 at the headend over WAN 912. The common PIN is stored in a memory at block 1208. As noted above, when client terminal 935 recognizes the presence of LAN 926 it sends an authentication request to the server terminal 929 seeking to access LAN 926. The client terminal's request to access LAN 926 is shown at block 1212 in FIG. 12.

At block 1215, client terminal 935 participates in an authentication process. In this illustrative example, the authentication process utilizes the shared-key authentication message flow shown in FIG. 10 and described in the accompanying text.

At block 1218, upon authentication, the client terminal 935 accesses the LAN 926. Client terminal 935 is thus able to share and exchange content with other authenticated terminals, including server terminal 929 in order to consume content recorded on its DVR. Thus, for example, a user can watch a recorded television show using a client terminal and coupled television in a bedroom of the house while another user watches television and records another program on the server terminal in the living room.

The client terminal 935 hosts a user interface such as GUI or EPG-type interface shown in FIG. 6 at block 1223 in FIG. 12. Client terminal 935 is operated responsively to user input to the user interface at block 1227. The illustrative method ends at block 1241.

Each of the processes shown in the figures and described in the accompanying text may be implemented in a general, multi-purpose or single purpose processor. Such a processor will execute instructions, either at the assembly, compiled or machine-level to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A method for provisioning a common PIN to one or more identified subscriber terminals among a plurality of terminals, each terminal in the plurality being coupled to a wide area network for receiving content from a service and connectable to a local area network, the method comprising:
using information from a subscriber billing database to identify, from the plurality of terminals, one or more terminals associated with a subscriber to the service; and
transmitting, over the wide area network, the common PIN for installation in the one or more identified subscriber terminals whereby the installed common PIN enables media content to be securely shared among the one or more identified subscriber terminals over the local area network.

2. The method of claim 1 in which the common PIN is used by the identified subscriber terminals to form a secure local area network by using shared-key authentication.

3. The method of claim 2 in which the secure local area network comprises a home network for sharing multimedia content that is stored on a DVR disposed in one of the identified subscriber terminals.

4. A method for enabling data to be securely shared over a coaxial cable network, the method comprising:
receiving a PIN from a controller over a first network operating on the coaxial cable network;
storing the PIN in a memory of a terminal;
authenticating the terminal using the PIN for shared-key authentication to thereby grant access to a second network operating on the coaxial cable network; and
communicating with authenticated terminals on the second network to thereby securely share data.

5. The method of claim 4 in which the first and second network are operated at different frequencies over the same physical infrastructure.

6. The method of claim 5 in which the physical infrastructure comprises a coaxial cable network capable of simultaneously supporting a multimedia content delivery network, an out-of-band signaling network and a local area network.

7. A network controller disposed at a headend of a wide area network that provides a service to a plurality of terminals coupled to the wide area network, comprising:
a billing system interface arranged to receive billing system data for identifying one or more terminals in the plurality of terminals that are associated with a subscriber to the service; and
a PIN server arranged to transmit a PIN over the wide area network responsively to the billing system data to the identified one or more subscriber terminals so that the identified one or more terminals are authenticated using the PIN to gain access to a local area network used to securely share data between authenticated terminals.

8. The network controller of claim 7 further including a switch for transmitting multimedia content to the plurality of terminals.

9. The network controller of claim 7 in which the service comprises a home networking service that supports sharing of media content among the identified one or more terminals over the local area network.

10. The network controller of claim 9 in which the home networking service is selected from one of whole home or multi-room DVR.

11. The network controller of claim 9 in which the home networking service is a MoCA (Multimedia over Coax Alliance) networking service.

12. The network controller of claim 7 in which the billing system data is used to identify one or more terminals authorized for receiving a service ordered by the subscriber.

13. The network controller of claim 7 in which the billing system data is used to identify one or more terminals for receiving discrete media content ordered by the subscriber.

14. A multimedia server, comprising:
a receiver for receiving, from a service provider over a wide area network, multimedia content and a PIN, whereby the PIN is commonly shared with the multimedia server and client terminals disposed on a local area network;
a memory for storing the media content and PIN received from the wide area network;
a network interface arranged for sharing a portion of the multimedia content with one or more authenticated client terminals on the local area network; and
authentication logic for authenticating a client terminal seeking access to the local area network based on the commonly shared PIN.

15. The multimedia server of claim 14 in which the memory is a hard disk drive that is shared with a DVR.

16. The multimedia server of claim 14 in which the memory is further arranged to store multimedia content that is received from an authenticated client terminal over the local area network where the multimedia content is selected from one of video, music, pictures, or data.

17. The multimedia server of claim 14 in which the local area network is an IP network.

18. The multimedia server of claim 14 in which the authenticating comprises challenge-response using the commonly shared PIN.

19. The multimedia server of claim 18 in which the challenge-response includes generation of random number as a challenge which is encrypted as a response by a client terminal.

20. A computer-readable medium containing instructions which, when executed by one or more processors in an electronic device, performs a method comprising:
receiving a PIN from a first network;
requesting access to a second network using the received PIN to participate in an authentication process, the first network and second network sharing a portion of a common physical infrastructure and each operating at a different frequency on the shared portion of common physical infrastructure; and
accessing data stored on a device disposed on the second network when the requested access to the second network is granted.

21. The computer-readable medium of claim 20 in which the first network is a wide area network selected from one of cable network, digital cable network, satellite network, direct broadcast satellite network, telecommunications network, wireless network under IEEE 802.11 or Bluetooth, or digital subscriber line network and the second network is a local area network selected from one of coaxial cable network, MoCA (Multimedia over Coax Alliance) network, HomePlug network, HPNA (Home Phoneline Networking Alliance) network, powerline network, or telephone network.

22. The computer-readable medium of claim 20 further including a step of providing a user interface for navigating content that is accessible on the second network.

23. The computer-readable medium of claim 20 in which the requesting is performed using a MAC message transported on the datalink layer of an OSI model.

24. The computer-readable medium of claim 20 in which access to the second network is not granted to terminal devices that have not received the PIN from the first network.
